(19) United States
(12) Patent Application Publication
(10) Pub. No.: US 2004/0241399 A1
(43) Pub. Date: Dec. 2, 2004

(54) Pattern bonded nonwoven fabrics

(76) Inventors: Samuel E. Marmon, Gallatin, TN (US); Edgar N. Rudisill, Nashville, TN (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/393,969

(22) Filed: Mar. 21, 2003

(51) Int. Cl. B32B 27/14; B32B 3/00; D04H 3/16; D04H 1/56

(52) U.S. Cl. 428/196; 428/198; 442/409; 442/381; 442/382; 442/400; 442/401

(57) ABSTRACT

A pattern bonded nonwoven fabric comprising a nonwoven fiber web having a geometrically repeating and visually discernable base pattern of bond points having at least one shape with at least one area defined by the shape and a second visually distinguishable bond pattern incorporated within said base pattern.

### FIELD OF THE INVENTION

This invention is related to pattern bonded nonwoven fabrics having a secondary pattern bonded within a first bond pattern.

### BACKGROUND OF THE INVENTION

Many processes for producing bonded nonwoven fabrics are known in the art. In particular, it is known to apply heat and pressure for bonding at limited areas of a nonwoven web by passing it through the nip between heated calender rolls either or both of which may have patterns of lands and depressions on their surfaces. During such a bonding process, depending on the types of fibers making up the nonwoven web, the bonded regions may be formed autogenously, i.e., the fibers of the web are melt fused at least in the pattern areas, or with the addition of an adhesive.

It is known in the art that physical properties of bonded nonwoven fabrics are related to the degree and the pattern of bonding. In general, a large bonded area may be applied to provide dimensional stability to nonwoven fabrics, at the expense of flexibility and porosity, and geometrically repeating bond patterns are employed to provide isotropic dimensional stability. However, different property requirements for different uses may dictate the use of random or irregular patterns.

It would be useful if there were a way to use a visually distinguishable bond pattern to identify a fabric without significantly changing the characteristics of the fabric such as surface abrasion resistance, web strength and dimensional stability. U.S. Pat. No. 6,093,665 to Sayovitz et al. discloses a geometrically repeating base pattern of bonded regions wherein a regular pattern of some of the bond regions are removed to create a visually distinguishable bond pattern. However, the absence of some bond regions could lead to less bonding of the fabric resulting in a weaker fabric and more fabric fuzzing. If several adjacent bond points were removed even less bonding of the fabric would occur which could lead to an even weaker fabric and even more fabric fuzzing. It would be desirable to have a pattern bonded nonwoven fabric that maintains the number of bond points to maintain fabric strength and fabric fuzzing level, while changing the bond pattern sufficiently to create a visually distinguishable second bond pattern.

### SUMMARY OF THE INVENTION

One embodiment of the present invention is a pattern bonded nonwoven fabric comprising a nonwoven fiber web having a geometrically repeating and visually discernable base pattern of bond points having at least one shape with at least one area defined by the shape and a second visually distinguishable bond pattern incorporated within said base pattern.

### BRIEF DESCRIPTION OF THE DRAWINGS

FIG. 1 is an illustrative bond pattern of the present invention.

FIG. 2 is a magnified portion of the bond pattern in FIG. 1.

FIG. 3 is another illustrative bond pattern of the present invention.

### DETAILED DESCRIPTION OF THE INVENTION

The present invention provides nonwoven fabrics having one or more of visually recognizable and discernible secondary bond patterns. A visually recognizable secondary bond pattern is highly suited as an identification mechanism for nonwoven fabrics without significantly sacrificing useful properties of the fabrics, such as surface abrasion resistance, web strength and dimensional stability. Accordingly, the present invention can be used to create identification marks to denote various sources of origin, characteristics and properties of nonwoven fabrics, e.g., weight, composition, hydrophobicity, hydrophilicity and the like, and to denote designated uses for each fabric, e.g., medical applications, such as medical or surgical gowns or drapes, environmental uses, such as for articles of protective apparel, including jump suits, overalls, gloves, lab coats, and the like. In addition, the bond patterns can act as alignment or demarcation points to assist manufacturing processes in which articles, such as garments, diapers, protective clothings and the like, from such nonwoven fabrics are assembled or produced.

The present invention is useful for nonwoven fabrics having geometrically repeating base bond patterns. The size, shape, arrangement and pattern of bond points for the base bond patterns may vary widely as long as the patterns created by the base bond points are regular and repeating. Depending on required aesthetic effects and physical properties for different uses of the nonwoven fabrics, the size and/or shape of each bond point as well as the distance between adjacent bond points in a repeating bond pattern may vary. As mentioned above, the total bonded area of the fabric and size of bond points impart different properties to the nonwoven fabrics. For example, highly bonded areas tend to impart dimensional stability, while lesser bonded areas provide flexibility, drapability and porosity. Of the various base bond patterns, particularly useful patterns are evenly spaced repeating bond patterns having bond points of uniform shape and size.

The present invention is directed toward pattern bonded nonwoven fabrics having a visually distinguishable secondary bond pattern, incorporated within the base bond pattern, that can be used to identify a fabric without significantly changing the characteristics of the fabric such as surface abrasion resistance, web strength and dimensional stability. This is achieved by using a pattern bonded nonwoven fabric with a geometrically repeating and visually discernable base bond pattern of bond points having at least one shape with at least one area defined by the shape and wherein some of the base bond points are replaced with bond points distinct from the base bond points, such as by having the same shape bond point with a different area, a different shape bond point and the same area, or a different shape bond point with a different area, to provide a distinct and visually distinguishable secondary bond pattern incorporated within the geometrical base bond pattern.

The base bond pattern is made up of bond points that exhibit one or more combinations of shape and size in a particular arrangement. This pattern may vary as long as the patterns created by the bond points are regular, repeating and visually discernable.

The bond points of the pattern bonded nonwoven fabric (the total bonded area) cover from about 6% to about 50%, preferably from about 10% to about 40% of the surface of the nonwoven fabric. The identifiable and base bond points separately cover from about 3% to about 47%, preferably from about 5% to about 35% of the surface of the nonwoven fabric. Bonding too large an area could result in a stiff, harsh fabric, while bonding too small an area could result in a weak fabric. The bond point density of the pattern bonded nonwoven fabric is from about 8 to about 128 bond points per cm², preferably from about 12 to about 64 bond points per cm². The area of any individual bond point is less than about 0.3 cm², preferably less than about 0.2 cm². The area of an individual identifiable secondary bond point is from about 25% to about 300%, preferably from about 40% to about 250% of the area of an individual base bond point.

Many shapes of bond points can be used, including but not limited to circles, ovals, squares, diamonds, lines and crosses.

Nonwoven webs suitable for producing the present nonwoven fabrics are any known nonwoven webs that are amenable to pattern bonding, which include, but are not limited to, fiber webs fabricated from staple fibers, continuous fibers or mixtures thereof, and the fibers may be natural, synthetic or mixtures thereof. In addition, suitable fibers may be crimped or uncrimped, and synthetic fibers may be monocomponent fibers or multicomponent conjugate fibers, e.g., bicomponent side-by-side or sheath-core fibers.

Illustrative of suitable natural fibers include cellulosic fibers, cotton, jute, pulp, wool and the like. When natural fiber webs are utilized, a binder or an adhesive, in the form of fibers or powders, may be sprayed on or mixed with the fibers of the web to consolidate the constituent fibers or otherwise applied to form bonded regions. Illustrative of suitable binders include ethylene vinylacetate, acrylate adhesives, acrylic adhesives, latex and the like.

Synthetic fibers suitable for the present invention are produced from synthetic thermoplastic polymers that are known to form fibers, which include, but are not limited to, polyolefins, e.g., polyethylene, polypropylene, polybutylene and the like; polyamides, e.g., nylon 6, nylon 6/6, nylon 10, nylon 12 and the like; polyesters, e.g., polyethylene terephthalate, polybutylene terephthalate and the like; polycarbonate; polystyrene; thermoplastic elastomers; vinyl polymers; polyurethane; and blends and copolymers thereof. Additionally suitable fibers include glass fibers, carbon fibers, semi-synthetic fibers, e.g., viscose rayon fibers and cellulose acetate fibers, and the like. In accordance with known properties of each polymer, synthetic and semi-synthetic polymer fibers can be bonded autogenously, i.e., the fibers of the web are melt-fused under heat and pressure, or with the use of a binder. For example, fiber webs of polyolefins, polyamides, polyesters, vinyl polymers or the like can be autogenously bonded, and webs of glass fibers and/or carbon fibers require the use of a binder.

Suitable staple fiber webs may be prepared by carding a mass of staple fibers with a woolen or cotton carding machine or a garnetting machine, and suitable continuous fiber webs may be prepared by conventional air laying methods that produce webs from meltblown fibers and/or spunbond fibers. As used herein, the term “meltblown fibers” indicates fibers formed by extruding a molten thermoplastic polymer through a plurality of fine, usually circular, die capillaries as molten threads or filaments into a high velocity gas stream which attenuates the filaments of molten thermoplastic polymer to reduce their diameter. In general, meltblown fibers have an average fiber diameter of up to about 10 microns. After the fibers are formed, they are carried by the high velocity gas stream and are deposited on a collecting surface to form a web of randomly dispersed meltblown fibers. Such a process is disclosed, for example, in U.S. Pat. No. 3,849,241 to Butin. As used herein, the term “spunbond fibers” refers to small diameter fibers that are formed by extruding a molten thermoplastic polymer as filaments from a plurality of fine, usually circular, capillaries of a spinneret. The extruded filaments are then rapidly drawn by an eductive or other well-known drawing mechanism. The resulting fibers, in general, have an average diameter larger than that of meltblown fibers. Typically, spunbond fibers have an average diameter in excess of 12 microns and up to about 55 microns. The production of spunbond webs is disclosed, for example, in U.S. Pat. Nos. 4,340,563 to Appel et al. and 3,692,618 to Dorschner et al.

The fabrics of the present invention further include laminates of two or more of the above-mentioned nonwoven webs and laminates of nonwoven webs and films. A useful example of a laminate containing multiple webs is a sandwich structure with spunbond webs on the outside of the laminate to provide strength with one or more meltblown webs inside of the laminate between the spunbond webs to provide various filtering capabilities. Various films known in the art, particularly thermoplastic films, can be bonded to the nonwoven webs, autogenously or with the use of a binder, to provide added barrier properties, such as moisture, chemical and aroma barrier properties. Useful thermoplastic films can be produced from, for example, polyolefins, e.g., polyethylene, polypropylene, polybutylene and the like; polyamides, e.g., nylon 6, nylon 6/6, nylon 10, nylon 12 and the like; polyesters, e.g., polyethylene terephthalate, polybutylene terephthalate and the like; polycarbonate; polystyrene; thermoplastic elastomers; vinyl polymers; polyurethane; and blends and copolymers thereof.

The present invention can be practiced employing any pattern bond forming process known in the art. Preferably, the bond pattern is applied using a conventional calender bonding process. In general, the calender bonding process employs pattern roll pairs for bonding at limited areas of the web by passing it through the nip between the rolls, at least one of which rolls is heated and has a pattern of lands and depressions on its surface. Alternatively, the bond pattern can be applied by passing the web through a gap formed by an ultrasonic work horn and anvil. The anvil may be in the form of a roll having raised portions to provide a pattern bonded fabric.

The temperature of the pattern rolls and the nip pressure should be selected so as to effect bonding without having undesirable accompanying side effects such as excessive shrinkage or web degradation. Although appropriate roll temperatures and nip pressures are generally influenced to an extent by parameters such as web speed, web basis weight, fiber characteristics, presence or absence of adhesives and the like, it is preferred that the roll temperature be in the range between softening and crystalline melting temperatures of the component fiber polymer in combination with nip pressures on raised points (pin pressure) of about 7 MPa to about 350 MPa. It may not be desirable to expose the web to a temperature where extensive fiber melting occurs. For example, the preferred pattern bonding settings for polypropylene webs are a roll temperature in the range of about 127° C. and 160° C., and a pin pressure in the range of about 7 MPa to about 700 MPa. However, when adhesives other than melt-adhesives are utilized to consolidate and to form the present bond pattern, no significant heat and pressure need to be applied since only a minimal pin pressure is needed to hold the fibers in place until the adhesives cure to form permanent bonds.

Suitable pattern rolls for the present invention may be produced from well known materials, such as steels for patterned rolls and high temperature rubbers for smooth rolls, and according to processes well known in the art. The pattern rolls may be produced from a mold containing desired patterns. Suitable pattern roll forming procedures are well known in the engraving art. The bond patterns of the present invention, as an alternative to the above-described in-line roll patterning process, can also be formed by stamping processes known in the art, using male and female molds.

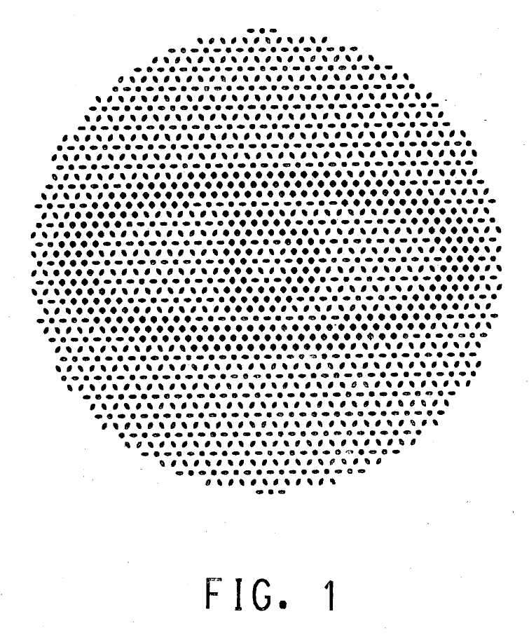

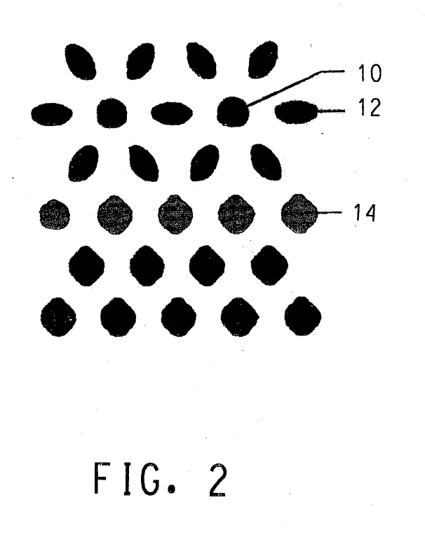

FIG. 1 provides an illustrative example of the bond pattern of the present invention. A second visually distinct bond pattern of a capital D within an oval can be seen within the geometrically repeating base bond pattern. FIG. 2 provides a magnified portion of FIG. 1. The geometrically repeating base bond pattern is made up of circular 10 and oval 12 bond points. The circles 10 are surrounded by six ovals 12 radiating outwardly from the circles 10 creating a nested daisy flower pattern. Each oval 12 is adjacent to two circles 10. The base bond points can all be of the same shape or different shapes. The visually identifiable second bond pattern is made up of diamond-shaped bond points 14. Each diamond 14 has replaced either a circle 10 or an oval 12. All of the diamonds in FIG. 1 produce a capital D within an oval. It is further noted that many diamond bond points 14 are adjacent to one another.

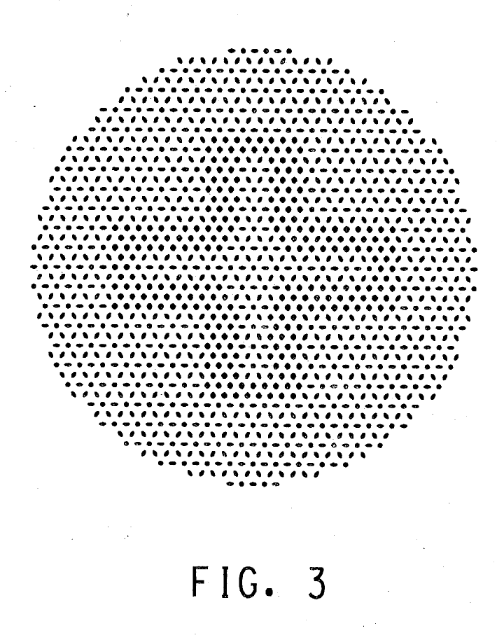

FIG. 3 provides another illustrative example of the bond pattern of the present invention. The outline of a visually identifiable cross bond pattern can be seen on the geometrically repeating base bond pattern. Similar to FIG. 2, the geometrically repeating base bond pattern is made up of circular 10 and oval 12 bond points to create a nested daisy flower pattern. The visually identifiable second bond pattern is made up of diamond-shaped bond points 14. Each diamond 14 has replaced either a circle 10 or an oval 12. All of the diamonds in FIG. 3 produce an outline of a cross.

### Test Methods

The following examples employed the following test methods. ASTM refers to the American Society for Testing and Materials. INDA refers to the Association of the Nonwoven Fabric Industry.

Basis Weight is a measure of the mass per unit area of a fabric and was determined by ASTM D 3776, which is hereby incorporated by reference, and is reported in g/m².

Grab Tensile Strength is a measure of the breaking strength of a fabric and was conducted according to ASTM D 5034, which is hereby incorporated by reference, and is reported in Newtons (N).

Elongation is a measure of the amount a fabric stretches prior to failure (breaking) in the grab tensile strength test and was conducted according to ASTM D 5034, which is hereby incorporated by reference, and is reported as a percent.

Handle-O-Meter is a measure of the drapability of a fabric and was measured according to INDA 90.3-92, which is hereby incorporated by reference, and is reported in grams (g).

### EXAMPLE 1

A three-layer fabric was created using a bond pattern of this invention that contains a visually distinguishable secondary pattern of bond points in a geometrically repeating pattern of base bond points as illustrated in FIG. 1. The three-layer fabric comprised two outer layers of spunbond fibers and a central layer of meltblown fibers made according to the process disclosed in WO 0109425 to Rudisill et al. hereby incorporated by reference. The spunbond fibers were sheath-core bicomponent fibers in which the core comprised polyethylene terephthalate and the sheath comprised polyethylene. The ratio of sheath to core was 50% by weight. The central layer was made of side-by-side bicomponent meltblown fibers in which one component was polyethylene terephthalate and the other was polyethylene. The polyethylene terephthalate resin comprised about 65% by weight of the fiber. The weight of each spunbond layer was 21 g/m² and the weight of the meltblown layer was 17 g/m². The three layers were fed to a nip of a calender apparatus comprised of upper and lower steel heated rolls. The upper roll was engraved with secondary pattern of diamond-shaped bond elements creating a capital D within an oval, incorporated within the base bond pattern of nested daisies, as illustrated in FIG. 1 and the lower roll was a smooth anvil roll. Referring to FIG. 2, the circles 10 and ovals 12 cover 15% of the surface of the fabric. The diamonds 14 cover 20% of the surface of the fabric. The bonded point density of the fabric is 34 points per cm². Both rolls were about 46 cm in diameter and heated to about 120° C. with a nip pressure setting of 35 kN per linear m. Handle-O-Meter and Grab Tensile and Elongation data are in the Table.

### Comparative Example A

The same three-layer fabric of Example 1 was used except that fabric was bonded using only the base pattern of bond points. Handle-O-Meter and Grab Tensile and Elongation data are in the Table.

Comparing the data from the Table, it is clear that the bond pattern of the present invention does not significantly degrade the physical properties of the nonwoven fabric while providing visually identifiable secondary bond patterns.

TABLE
NONWOVEN WEB PROPERTIES

| Exam- | H-O-M (MD) | H-O-M (XD) | Grab Tensile (XD) | Elongation |
|---|---|---|---|---|
| ple | (g) | (g) | (N) | (XD) (%) |
| 1 | 27.4 | 11.1 | 91.6 | 82.6 |
| A | 25.6 | 10.1 | 87.6 | 81.1 |

H-O-M = Handle-O-Meter & XD = Cross Direction

### EXAMPLE 2

FIG. 3 shows another example of the present invention. A visually distinguishable bonding pattern of an outline of a cross can be seen on the geometrically repeating base bond pattern. Similar to FIG. 2, the geometrically repeating base bond pattern is made up of circular 10 and oval 12 bond points to create a nested daisy flower pattern. The visually identifiable secondary bond pattern is made up of diamond-shaped bond points 14. Each diamond 14 has replaced either a circle 10 or an oval 12.

All of the diamonds in FIG. 3 produce an outline of a cross. The circles 10 and ovals 12 cover 15% of the surface of the fabric. The diamonds 14 cover 20% of the surface of the fabric. The bonded point density of the fabric is 30 points per cm².

What is claimed is:

1. A pattern bonded nonwoven fabric comprising a nonwoven fiber web having a geometrically repeating and visually discernable base pattern of bond points having at least one shape with at least one area defined by the shape and a second visually distinguishable bond pattern incorporated within said base pattern.

2. The pattern bonded nonwoven fabric of claim 1, wherein some of the bond points of the base bond pattern are replaced with second pattern bond points having different shapes and/or areas from the bond points of the base bond pattern.

3. The pattern bonded nonwoven fabric of claim 2, wherein the second pattern bond points are of the same shape of the base pattern bond points with a different area.

4. The pattern bonded nonwoven fabric of claim 2, wherein the second pattern bond points are of a different shape from the base pattern bond points with the same area.

5. The pattern bonded nonwoven fabric of claim 2, wherein the second pattern bond points are of a different shape from the base pattern bond points and a different area.

6. The pattern bonded nonwoven fabric of claim 1, wherein the fabric comprises a laminate of at least one nonwoven fiber web and at least one film.

7. The pattern bonded nonwoven fabric of claim 1, wherein the nonwoven fiber web is selected from staple fiber nonwoven webs, spunbond nonwoven webs and meltblown nonwoven webs.

8. The pattern bonded nonwoven fabric of claim 1, wherein the fabric comprises multiple nonwoven webs.

9. The pattern bonded nonwoven fabric of claim 8, wherein the fabric comprises a first spunbond nonwoven web, at least one meltblown nonwoven web and a second spunbond nonwoven web.

10. The pattern bonded nonwoven fabric of claim 2, wherein the area of an individual secondary pattern bond point is from about 25% to about 300% of the area of an individual base pattern bond point.

11. An article of protective clothing comprising the pattern bonded nonwoven fabric according to claim 1.

12. A medical drape comprising the pattern bonded nonwoven fabric according to claim 1.
